(19) United States
(12) Patent Application Publication
(10) Pub. No.: US 2017/0332608 A1
(43) Pub. Date: Nov. 23, 2017

(54) Top Bar Nucleus Hive

(71) Applicant: PAC Basic, LLC, Eleva, WI (US)

(72) Inventor: Andrew Pedersen, Eleva, WI (US)

(21) Appl. No.: 15/598,535

(22) Filed: May 18, 2017

Related U.S. Application Data
(60) Provisional application No. 62/338,645, filed on May 19, 2016.

(51) Int. Cl. A01K 49/00

(52) U.S. Cl. CPC A01K 49/00

(57) ABSTRACT

A bee nucleus enclosure is formed with a tray and a cover positioned on top of the tray. The tray includes an aperture through which bees can exit and enter the enclosure. The size and shape of the enclosure is such that once a colony of a suitable maturity has developed within the enclosure the entire colony can be transferred to a bee house/box to enable the colony to populate the bee house/box.

### CROSS-REFERENCE TO RELATED APPLICATIONS

This application claims priority from U.S. Provisional Patent Application Ser. No. 62/338,645, filed on May 19, 2016, the entirety of which is expressly incorporated herein by reference for all purposes.

### FIELD OF THE INVENTION

The present invention relates generally to insect/bee farming or husbandry and more particularly to an enclosure for bee husbandry.

### BACKGROUND OF THE INVENTION

In insect/bee farming or husbandry, the types of enclosure in which the bees are allowed to grow or be transferred is important for proper care of the bees and for the harvesting of the honeycombs from the enclosure.

However, while mature bee colonies can be placed in standard bee hive houses/boxes, in order to grow into a sustainable colony it is necessary to incubate the bee colony in a smaller enclosure. Once the colony has matured sufficiently it can be placed within the standard bee hive box. Further, if the new colony is grown in a larger hive, an appropriate transfer container is necessary.

Prior art enclosures have certain deficiencies that limit the effectiveness of these enclosures as bee colony incubators for a top bar hive application. Thus, it is desirable to develop an enclosure for the incubation of a bee colony that can overcome the problems associated with prior art enclosures.

### SUMMARY OF THE INVENTION

According to one exemplary embodiment of the present invention, a bee incubation/transfer enclosure or nucleus box/hive is formed with a tray and a cover positioned on top of the tray. The tray includes an aperture through which bees can exit and enter the enclosure. The size and shape of the enclosure is such that once a colony of a suitable maturity has developed within the enclosure the colony can be transferred to a bee house/box to enable the colony to populate the bee house/box.

According to another exemplary embodiment of the invention, the components of the incubation enclosure/nucleus box are each formed of a blank of a lightweight and readily formable material that can be readily erected into the component for ease of manufacture, transport and erection of the incubation/transfer enclosure.

Numerous other aspects, features, and advantages of the present invention will be made apparent from the following detailed description together with the drawings figures.

### BRIEF DESCRIPTION OF THE DRAWINGS

The drawings illustrate the best mode currently contemplated of practicing the present invention.

In the drawings:

FIG. 1 is a front perspective view of one exemplary embodiment of a top bar incubation enclosure constructed according to the present disclosure;

FIG. 2 is a partially broken away perspective view of the enclosure of FIG. 1;

FIG. 3 is a top plan view of one exemplary embodiment of a blank from which the cover of the enclosure of FIG. 1 is constructed; and

FIG. 4 is a top plan view of one exemplary embodiment of a blank from which the tray of the enclosure of FIG. 1 is constructed.

### DETAILED DESCRIPTION OF THE INVENTION

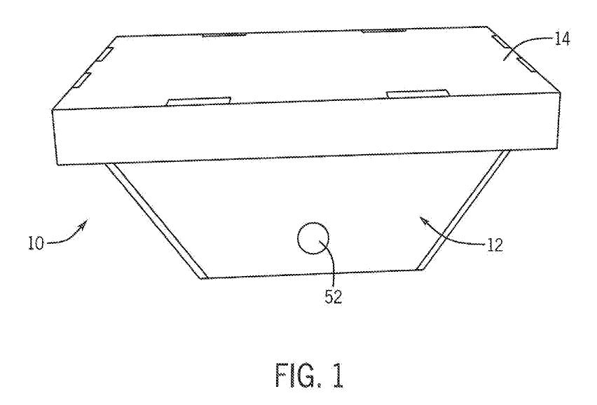

Referring now in detail to the drawing figures, wherein like reference numerals represent like parts throughout the several views, in the exemplary embodiment illustrated in FIG. 1 a bee incubation/transfer enclosure or nucleus box is illustrated generally at 10. The enclosure includes a tray 12 and a cover 14 disposed over an open upper end 16 of the tray 14.

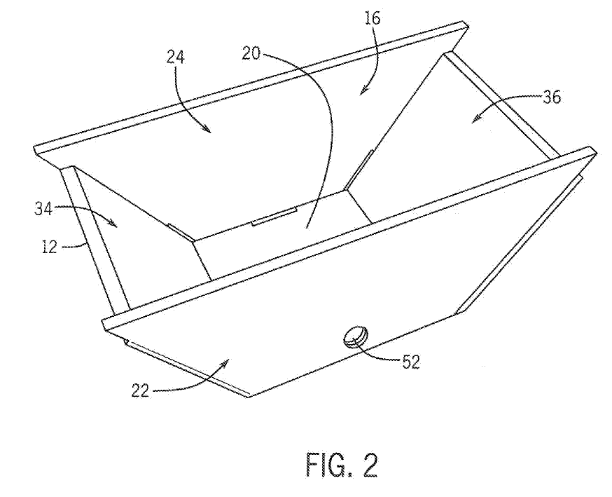

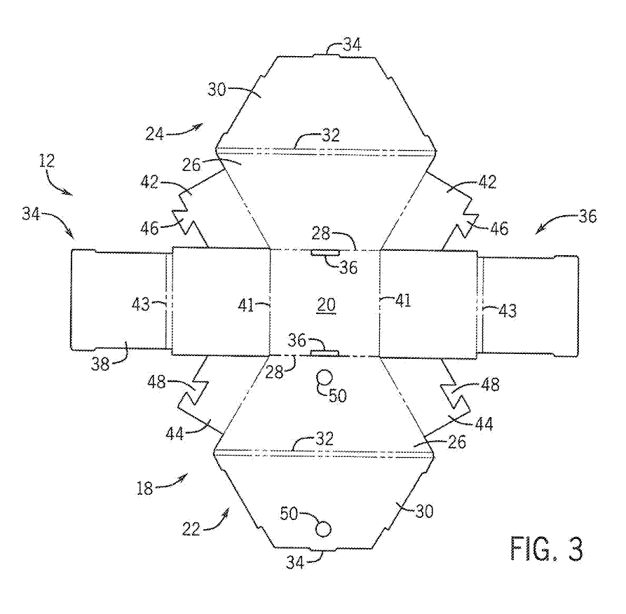

Looking now at FIGS. 1-3, the tray 14 is formed from a blank 18 of a suitable material, such as a corrugated material formed of paperboard or plastic. The blank 18 includes a bottom 20 and a pair of side panels 22,24 extending outwardly from each side of the bottom 20. The side panels 22,24 each include an inner portion 26 joined at a hinge 28 to the bottom 20 and an outer portion 30 joined to the inner portion 26 via hinge 32. The inner portion 26 and outer portion 30 are formed with mirror image shapes, such that the inner portion 26 and outer portion 30 can form the dual thickness side panel 22,24 when folded towards the bottom 20. The outer portion 30 includes a locking tab 34 opposite the hinge 32 that is engaged within a corresponding slot 36 formed in the bottom 20 in order to secured the outer portion 30 to the bottom 20 when the side panels 22,24 are formed.

The tray 14 also includes a pair of end panels 34,36 connected to the bottom 20 and disposed between the side panels 22,24. The end panels 34,36 are also formed with an inner portion 38 and an outer portion 40 that are connected to one another to be folded to form a dual thickness end panel 34,36.

To hold the end panels 34,36 in the folded configuration, a pair of locking panels 42,44 are disposed on each inner portion 26 of the side panels 22,24. After folding the end panels 34,36 inwardly towards the bottom 20, when the side panels 22,24 are folded towards the bottom 20, the locking panels 42,44 are placed in an overlapping configuration against the outer surfaces of the end panels 34,36. In this position, a locking tab 46 on locking panel 42 can be engaged with a locking notch 48 on panel 44 to engage the locking panel 42,44 with one another and hold the end panels 34,36 in the erected position.

The side panel 22 also includes a pair of apertures 50 disposed in the inner portion 26 and the outer portion 30 that are aligned with one another when the side panels 22,24 are erected. The apertures 50 form an opening 52 in the tray 12 through which bees can enter and exit the enclosure 10. In other embodiments the opening 52 can be disposed in other walls of the enclosure 10, or multiple opening 52 can be utilized.

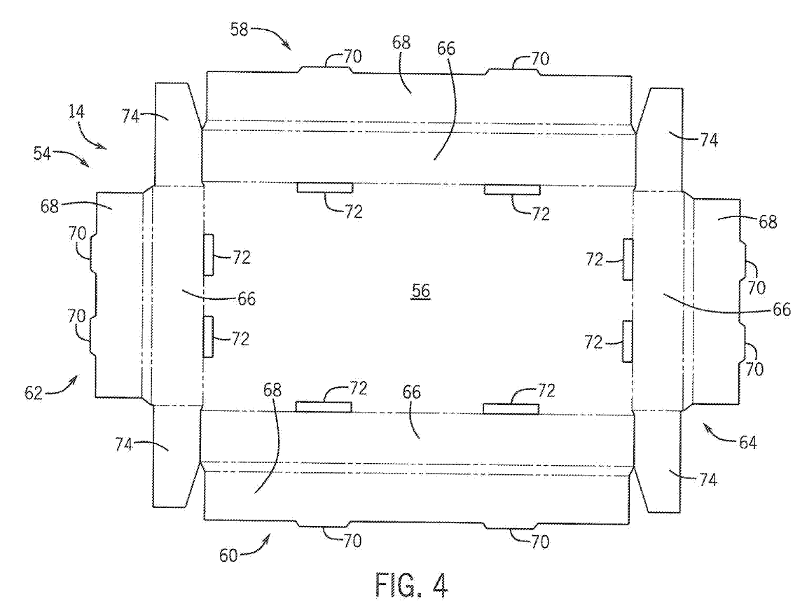

Referring now to FIGS. 1 and 4, the cover 14 is shaped to have a perimeter slightly greater than the perimeter of the open upper end 16 of the tray 14 in order to enable the cover 16 to be positioned and frictionally or otherwise retained on the tray 12 directly over the open upper end 16 of the tray 14. The cover 14 can be formed of materials similar to that used for the tray 12 and is initially formed from a blank 54 of the material. The blank 54 includes a central portion 56 having a pair of opposed side walls 58,60 attached thereto with a pair of opposed end walls 62,64 secured to the central section 56 between the side walls 58,60.

Each of the side walls 58,60 and the end walls 62,64 are formed with an inner part 66 folds and is attached to the central section 56 and an outer part 68 folds and is attached to the inner part 66. The outer part 68 is foldable over the inner part 66 and engage with the central section 56 using tabs 70 disposed on the outer part 68 that are positional within slots 72 formed in the central section 56. Further, end walls 62,64 each include locking flaps 74 that are positional between the inner part 66 and outer part 68 of the side walls 58,60 to hold the end walls 64,66 and side walls 58,60 in engagement with one another.

In use, the blanks 18 and 54 are folded to erect the tray 12 and the cover 14 and form the enclosure 10. Bees can then be introduced into the enclosure 10 directly or the enclosure 10 can be placed in a top bar nucleus (not shown) to assist the bees in forming a sustainable colony. Current nucleus boxes available cater to the Langstroth hives, which are cumbersome for compatibility or transfer to a top bar hive. In the illustrated exemplary embodiment, the angle of the end panels 34,36 relative to the bottom 20 of the top bar nucleus hive allows the comb formed by the bees within the enclosure/box 10 to be grown in compatibility for placement within a hive box, not shown. For example, the configuration for the enclosure 10 enables a number of enclosures 10 to be placed in a stacked configuration within the hive. The angle of the end panels 34,36 to provide this function can be between 112 degrees and 120 degrees, with an angle of 116 degrees being especially preferred.

Further, if the enclosure 10 is formed of a corrugated paperboard material, the enclosure 10 can be biodegradable such that it is not required to remove the enclosure 10 from within the box in which it is positioned, as the paperboard material forming the enclosure 10 will degrade naturally.

Further, while the illustrated exemplary embodiment for the enclosure 10 has the illustrated configuration and shape for the tray 12 and the cover 14, it is also contemplated that the shapes of the tray 12 and cover 14, as well as their constituent parts can have other alternative configurations.

Various other embodiments of the present invention are contemplated as being within the scope of the filed claims particularly pointing out and distinctly claiming the subject matter regarded as the invention.

1. A bee nucleus enclosure comprising:
a) a tray having an open upper end and including at least one opening through which bees may enter and exit the enclosure; and
b) a cover releasably positioned on the tray over the open upper end.

2. The enclosure of claim 1 wherein the tray comprises:
a) a bottom wall;
b) a pair of opposed side walls joined to the bottom wall; and
c) a pair of opposed end walls joined to the bottom wall and engageable with the pair of side walls.

3. The enclosure of claim 2 wherein the end walls are disposed at an angle of between 112 degrees and 120 degrees with respect to the bottom wall.

4. The enclosure of claim 1 wherein the tray is formed of a corrugated material.

5. The enclosure of claim 1 wherein the tray is formed of a biodegradable material.

6. The enclosure of claim 1 wherein the cover is formed of a corrugated material.

7. The enclosure of claim 1 wherein the cover is formed of a biodegradable material.

8. The enclosure of claim 1 wherein the cover is frictionally engaged with the tray.

9. The enclosure of claim 1 wherein the tray is trapezoidal in shape.

10. A method of incubating and transferring bees to form a sustainable bee colony,
the method comprising the steps of:
a) providing the enclosure of claim 1;
b) placing bees within the enclosure; and
c) moving the enclosure to a top bar hive.

11. A top bar hive comprising:
a) a hive box; and
b) a number of bar nucleus enclosures disposed within the hive box.
